(19) United States
(12) Patent Application Publication
(10) Pub. No.: US 2008/0018020 A1
(43) Pub. Date: Jan. 24, 2008

(54) Molding of golf ball covers and inner layers

(76) Inventors: Robert A. Wilson, Sagamore, MA (US); Michael F. Vieira, Acushnet, MA (US); Ajay Vora, Randolph, MA (US)

Correspondence Address: ACUSHNET COMPANY, 333 BRIDGE STREET, P. O. BOX 965, FAIRHAVEN, MA, 02719, US

(21) Appl. No.: 11/490,956

(22) Filed: Jul. 21, 2006

(51) Int. Cl. B28B 3/02

(52) U.S. Cl. 264/319; 264/335

(57) ABSTRACT

A method of molding an inner or cover layer of a thermoset or thermoplastic material around a golf ball core within a compression mold, in which the core is positioned within a mold cavity containing preformed inner hemispherical shells and holding the opposing mold portions in a closed position wherein heat and pressure are applied. Knockout pins engage the core and layer to biasly eject it from the mold cavity, while simultaneously blowing high pressure air into the mold cavity to aid in releasing the core and layer without the need of a release agent coating the cavities.

### FIELD OF THE INVENTION

The present invention relates to a compression mold and a method for compression molding using ejector pins and injecting air back into the cavity to assist in ejecting the ball upon completion of the molding process.

### DESCRIPTION OF THE RELATED ART

Golf balls are typically comprised of a cover that is compression molded, injection molded, or cast over a golf ball core and which may include one or more wound or solid layers and also a liquid or solid center. Individual layers, including outer core layers, intermediate layers, inner cover layer and outer cover layers are generally either compression or injection molded.

Injection molding is generally conducted with a mold having at least one pair of mold cavities; e.g., an upper mold cavity and a lower mold cavity, which mated to form a spherical recess. In addition, a mold may include more than one mold cavity pair. Retractable positioning pins hold the core in the spherical center of the mold cavity pair. Once the core is positioned in the first mold cavity, the respective upper mold cavity is mated to the lower to close the mold. Cover material is melted at high temperature and injected at high pressures into the mold cavity and around the core. The positioning pins are withdrawn while the cover material is flowable to allow the material to fill in any holes caused by the pins. When the material is at least partially cured, the covered core is removed from the mold. The injection molding is typically conducted with plastic pressures upwards of about 12,000 psi. These high pressures tend to deform the golf ball core through compression. Also, equipment for injection molding typically includes extremely small air vents, which significantly limit the injection speed of the cover or layer material.

As with the above-referenced process, a casting process also utilizes pairs of mold cavities. In a casting process, a cover material, typically a thermoset polyurethane, is introduced into a first mold cavity of each pair. A core is then either placed directly into the cover material or is held in position (e.g., by an overhanging vacuum or suction apparatus) to contact the cover material in what will be the spherical center of the mold cavity pair. Once the cover material is at least partially cured (e.g., to a point where the core will not substantially move), the cover material is introduced into a second mold cavity of each pair, and the mold is closed. The mold is then subjected to heat and pressure to cure the cover material thereby forming a cover on the core.

Casting is the most common method of producing a urethane or urea layer on a golf ball. However, the materials typically used in casting require a relatively long gel time. Long gel times have the disadvantage of requiring long cure times for the material to set so that the ball can be removed from the mold. Additionally, once removed, cast golf balls usually require subsequent buffing and other finishing process steps. Another disadvantage of using materials with a long gel time is that they may require sacrificing one or more material properties, such as flexural modulus or resiliency.

Recently, a particular form of injection molding, reaction injection molding (“RIM”), has been receiving increased attention, particularly for the ability to mold a wider range of material, including materials with a short gel time, such as a polyurea based cover or layer in a golf ball. RIM is a process by which highly reactive liquid components are injected into a closed mold, mixed usually by impingement and/or mechanical mixing in an in-line device such as a “peanut mixer,” where they polymerize primarily in the mold to form a coherent, one-piece molded article. The RIM process usually involves a rapid reaction between the reactive liquids, often in the presence of a catalyst. The liquids are stored in separate tanks, preheated to about 90° F. to 150° F., metered in the desired weight to weight ratio and fed into an impingement mix head, with mixing occurring under high pressure, e.g., 1,500 to 3,000 psi. The material is then injected into the mold, in where the liquids react rapidly to gel and form polymers such as polyurethanes, polyurea, epoxies, and various unsaturated polyesters. Both the mix head and the mold are heated to insure proper injection viscosity of the material.

Because RIM involves a chemical reaction that transforms liquid monomers and/or adducts into polymers, the mold used therein does not need to withstand the high temperatures and high pressures in conventional injection molding. Plus, the RIM process is fast. The chemical reaction causes the material to set in less than one minute and in many cases in about 10 seconds or less. However, the close mold design in conventional RIM limits the thickness of the molded cover or layer to be no less than about 0.02 inches, and thinner covers and layers in golf ball are preferred for various reasons. Ultra-thin layers can provide a transition between a soft outer cover layer and a hard inner cover layer, providing a means to tune the golf ball's spin rate profile for medium to short iron play. Alternatively, as an inner cover layer, an ultra-thin layer can reduce driver spin.

RIM, however, is subject to technical challenges, one of which is eliminating or minimizing the production of flash. Flash is extra material formed during molding or casting that must subsequently be removed. Since the materials used in RIM can have low viscosity, they readily flow into any crevices or holes within the mold. If retractable pins are used, there will necessarily be some clearance between the pins and the holes in the mold in which the pins are mounted. Thus, low viscosity layer-forming materials have not heretofore been usable with retractable pin reaction injection molding. As a result, conventional RIM has been limited to using materials having longer gel times. Otherwise, extensive and oftentimes economically prohibitive post-mold processing is required to remove the resulting flash. Furthermore, extensive labor is often required to clean and maintain the mold after retractable pin reaction injection molding.

Compression molds typically include multiple pairs of mold cavities, each pair comprising first and second mold cavities that mate to form a spherical recess. In one exemplary compression molding process, a cover material is pre-formed into half-shells, which are placed, respectively, into each of a pair of compression mold cavities. The core is placed between the cover material half-shells and the mold is closed. The core and cover combination is then exposed to heat and pressure, which cause the cover half-shells to combine and form a full cover. Compression molding does not require a support member for the core or other components for adding materials. A major reason for using compression molding is that details on the compression molded product, such as dimples, are in general significantly sharper than dimples obtained using injection molding. However, compression molding does necessitate a mold release material to be applied to the cavity of the mold halves to aid in the removal of the molded product. The industry has generally relied upon a semi-permanent (sacrificial) mold release agent consisting primarily of either silicon or Teflon based polymer. These semi-permanent release agents often are applied by either spray gun or baked on the cavities of the mold at frequent intervals. Unfortunately, depending upon the materials molded, the cavities may require a new application of the release agent as often as every thirty minutes. While this creates a significant downtime in the manufacturing process, an even greater problem occurs downstream where particles of the release agent have a tendency to adhere to the surface of the molded product. Before the molded product can be printed or painted, this release agent must be cleansed off the surface therein necessitating a costly manufacturing step.

What is needed is an improved mold and method of molding for use in compression molding wherein the golf ball is ejected from the cavity without the use of a mold release material.

### SUMMARY OF THE INVENTION

An advantage of the present invention is that it may provide a quick change of any cavity (mold half) from either the top or bottom mold half without removal of the entire mold assembly.

Another advantage of the present invention is that only one O-ring is required, and it is easily removed therein allowing for the preferred high temperature baked-on mold release to be applied.

An embodiment of the present invention provides for the compression molding of an inner or cover layer around a golf ball core within a mold, wherein the method comprises placing preformed hemispherical inner layer shells, one in each of an opposing upper and a lower mold cavity, then placing the golf ball component in the lower mold cavity; then holding the opposing mold portions together in a closed position by a first tonnage. The mold portions are subsequently compressed toward each other to the closed position, wherein heat and pressure are applied. A knockout retainer plate is activated whereby knockout pins engage the golf ball to biasly eject it form the mold cavity, while simultaneously blowing high pressure air into the mold cavity to aid in releasing the ball. This method allows the golf balls to be removed from mold cavities and eliminates the need of a release agent to coat the cavities.

Another embodiment of the present invention provides for a compression mold for molding a layer on a golf ball core, in which the mold includes mating mold parts and one or more retractable ejector pins for releasing the ball and matrix from within a cavity formed by said mold parts. The pins being extendable into the cavity and retractable within the mold parts. The mold includes a high pressure air blow system for aiding in ejecting the ball from the cavity, such that a release agent may not be necessary.

### BRIEF DESCRIPTION OF THE DRAWINGS

FIG. 1 is a cross-sectional view of the compression mold of the present invention.

FIG. 2 is a across-sectional view of the lower mold frame detailing the ejection feature of the invention.

FIG. 3 is a cross-sectional view of the lower mold frame taken along line A-A of FIG. 2.

FIG. 4 is a cross-sectional view of the lower mold frame depicting the stationary vent pin.

FIG. 5 is an elevational view of the stationary vent pin.

FIG. 6 is a top view of the stationary vent pin of FIG. 5.

### DESCRIPTION OF THE PREFERRED EMBODIMENTS

The present invention is directed to a method of making layer or cover components in a golf ball. In particular, the invention is directed to the employment of aspects generally associated with injection molding and creating an improved compression molding process for forming thin layers or covers of thermoset or thermoplastic materials in a golf ball. Thin layer technology can provide an outer cover or a transition between a soft outer cover layer and a hard inner cover layer. This can provide the ball designer a means to tune the spin rate profile for medium to short iron play. Alternatively, as an inner layer, the thin layer can also act to reduce driver spin rates while maintaining wedge spin rates

Traditionally, for separating the molded product and matrix from the mold cavity during a compressor molding process, the industry has relied upon either a permanent or a semi-permanent (sacrificial) mold release agent consisting primarily of either silicon or Teflon based polymer. The permanent agents are generally baked-on at relatively high temperatures of 600° F. to 750° F. Because of the design of conventional compression molds frames, wherein O-rings are employed that cannot tolerate these high temperatures and therefore must be removed before applying the permanent release agent to the cavity, the hydraulic press must be shut down, utilities discontinued, and the entire frame removed from the press. Because of this inconvenience and subsequent production downtime, semi-permanent release agents, which can be sprayed-on at lower temperatures (250° F.-350° F.) are usually the type used. Depending upon the materials molded, the cavities may require an application of the release agent as often as every thirty minutes. While this may create a significant downtime in the manufacturing process, an even greater problem occurs downstream because particles of the release agent can adhere to the surface of the molded product, and thus before the molded product can be printed or painted upon, this release agent must be cleaned off the surface. In addition to avoiding of this problem, the present invention provides a benefit in addition to not requiring a mold release agent, in that plasma or in line corona surface treatment may be then used downstream. The present invention provides a means for capturing the benefits that are inherent with a compression molding process, and by utilizing injection molding principles eliminating some of the maintenance problems associated with compression molding.

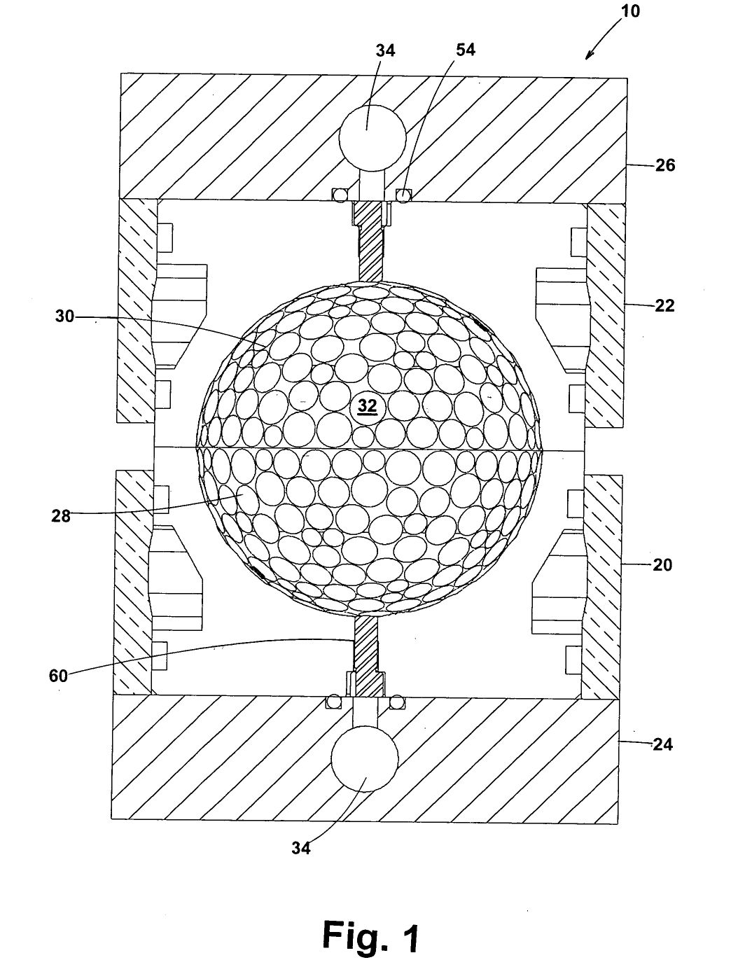

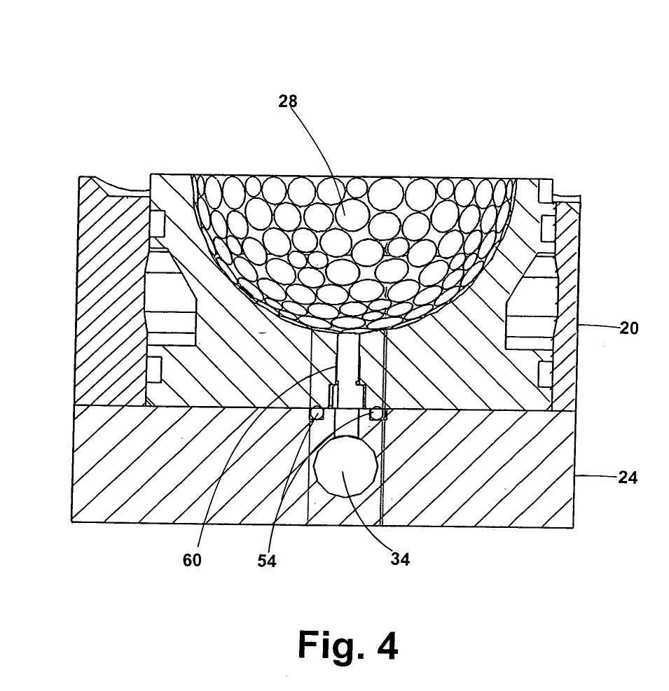

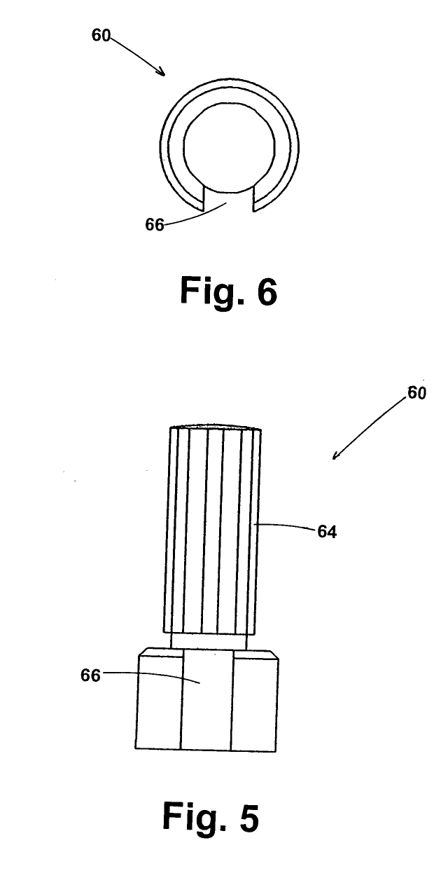

FIGS. 1 to 6 illustrate cross-sectional views of a compression mold 10 of the present invention. Mold 10 includes a lower mold frame 20, and an upper mold frame 22 that cooperate to mold a cover or an intermediate layer in a golf ball. Each frame 20, 22 has a respective lower and upper cavity retainer plate 24, 26 formed therein, and each plate 24, 26, has a respective lower and upper cavity 28, 30 defined therein, which when mated form a spherical recess 32 the approximate size of a golf ball. When used to form a golf ball cover, the mold cavities 28, 30 typically include a negative dimple pattern to impart the particular dimple arrangement on the cover during the molding process. Mold frames 20, 22 may also have additional cavities to cooperatively form a multi-molding frame. Mold frames 20, 22 may be arranged in a variety of orientations, but the “horizontal” orientation illustrated in the drawings is preferred.

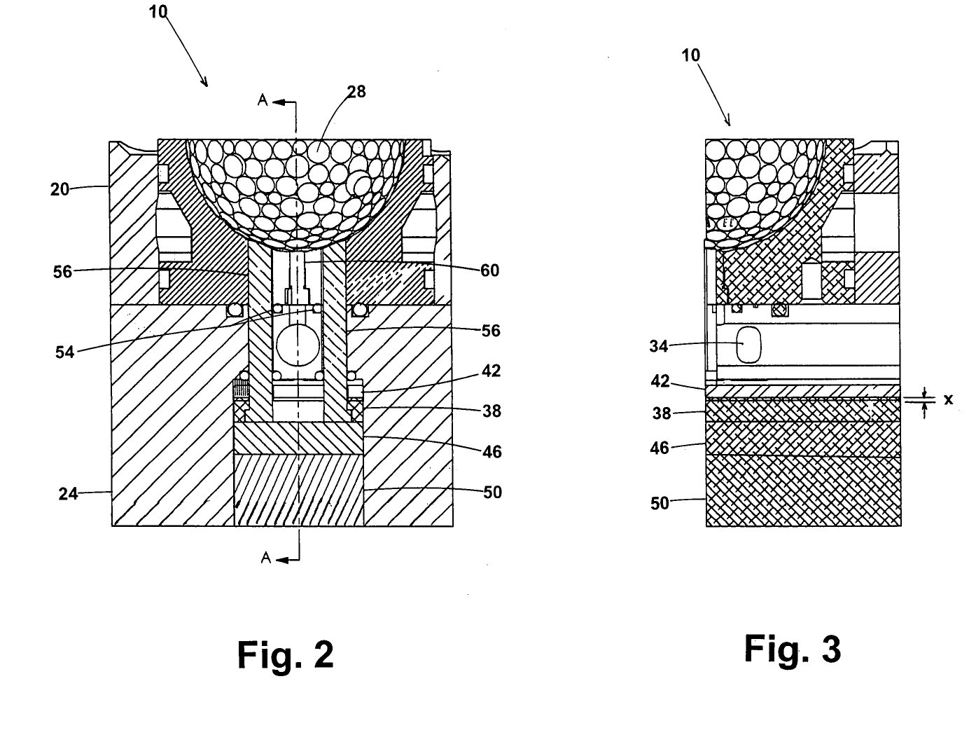

FIG. 1 depicts the mold frames 20 and 22 having channels 34 for the admittance of a gas (air) supply (not shown) and for creating a vacuum. FIGS. 2 and 3 show the lower frame 20 having an optional knockout assembly which consists of a knockout pin retainer plate 38, a stationary wedge 46, and a moving wedge 50. The frame 20 also contains a vacuum bushing assembly consisting of a vacuum bushing cap plate 42 which retains the O-ring seals 54 around a number of retractable knockout pins 56. The O-ring seals 54 and the pins 56 prevent matter from entering or exiting the mold.

A cover material (not shown) is pre-formed into half-shells, and each placed into one of the respective mold cavities 28, 30. The core (not shown) is then placed between the cover material half-shells and the mold 10 is closed. The core and cover combination is then exposed to heat and pressure, which cause the cover half-shells to combine and form a full cover. Compression molding does not require support members for the core or other components for adding materials. For convenience a core as herein described may have a cover or layer placed about it, and may be a ball product at any stage of manufacturing, such as a core with one or more layers already formed thereon. The orientation of knockout pins 56 is variable, but a vertical layout is preferred. The pins 56 are activated by the knockout pin retainer plate 38, which controls movement of pins 56 to engage with the core to forcefully remove the core out of the cavities 28. Knockout retainer plate 38, may be actuated in a variety of manners known within the art, such as electrically, hydraulically or pneumatically. The knockout retainer plate 38, limits the ejection stroke x of the knockout pins 56 to about 0.005 inch to 0.040 inch, and preferably about 0.022 inch injection stroke. Despite that conventional vent pins are configured with primary and secondary vents or porous tips to increase ventilation capacity, ventilation of trapped air and gasses inside the mold often remains a limiting factor in the speed at which material is injected into the mold cavity. If the vent holes are too small, poor ventilation can cause improper or inadequate venting of trapped air and gasses from the mold cavity during injection, which can have a deleterious effect on both the visual quality and durability of the newly formed layer. Conversely, if the vent holes are too large, the injected material flows there into and forms flash on the newly formed layer, thereby requiring substantial additional processing for removal of the flash and surface finishing. If the injection speed of the material is too fast, the speed of evacuating air and gasses out of the mold cavity during the injection process can cause the newly formed layer to scorch or not completely fill the mold cavity.

The present invention employs high pressure air blow, preferably with retractable knockout pins 56 to release molded products during the compression molding process. As shown on FIG. 1-6, stationary vent pin 60 is employed in combination with O-ring seals 54 to let high pressure air (80-250 psi) pass along machined flat areas 64 to create an air passageway around the vent pin upon the mold opening at the end of a molding cycle. The diameter of the vent pin 60 is slightly smaller than that of the surrounding bore to provide a tubular gap vent 66 of about 0.0002 inches to about 0.0005 inches. The vent pins 60 thus communicates the cavity space 28 with the exterior space for venting air during molding cycles, particularly while the mold 10 is in closed positions. Surfaces of the vent pin 60 facing the cavity space preferably have a concave profile and a substantially circular shape, resulting in circular dimples on the molded cover or outer cover layer. Alternatively, the surfaces can feature a convex profile and non-circular shape, such as oblong, elliptical, triangular, square, rectangular, pentagonal, hexagonal, polygonal, and the like. When the molded layer is other than a cover or an outer cover layer, the surfaces preferably have a concave profile and a substantially circular shape, as a spherical portion of the mold cavity 28.

Multiple retractable pins 56 are activated to eject the molded parts and matrix from the retainer plate 24. As previously stated the ejection stroke is about 0.005 inch to about 0.040 inch. The mold frame 20 has a vacuum cap plate 42, which retains the O-rings 54 around the knockout pins 56. The knockout pin retainer plate 38 controls the length of the pin 56 movement.

Just before the mold closes vacuum is added to remove trapped air, while air blow is activated upon the mold opening, Knockout pins 56 may be activated from the upper mold frame 22 and immediately followed by the lower mold frame 20 for a few seconds. Once the mold is fully opened, the pins 56 are retracted and the molded product is unloaded. For use with multiple cavities, a segmented manifold concept can be used with controlled activation of each segment. Manufacturing costs may be substantially reduced by eliminating the need for a mold release agent, as well as improving the efforts for developing simpler surface prep processes and one coat paint systems. Important health considerations are gained by eliminating release agents from compression molding because these agents are normally applied by spray guns which typically have a significant over spray released to the surrounding atmosphere.

The golf ball produced may be a two-piece, multi-layer, or wound ball having cores, intermediate layers, covers and/or coatings. A “cover” or a “core” as these terms are used herein includes a structure comprising either a single mass or one with two or more layers. As used herein, a core described as comprising a single mass means a unitary or one-piece core. The layer thus includes the entire core from the center of the core to its outer periphery. A core, whether formed from a single mass, two or more layers, or a liquid center may serve as a center for a wound ball. An intermediate layer may be incorporated, for example, with a single layer or multi-layer cover, with a single mass or multi-layer core, with both a single layer cover and core, or with both a multi-layer cover and a multi-layer core. A layer may additionally be composed of a tensioned elastomeric material. Intermediate layers of the type described above are sometimes referred to in the art, and, thus, herein as well, as an outer core layer, an inner cover layer, an outer core layer, or a mantle layer.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. For example, while the method and apparatus of the present invention have been described above as forming a golf ball product, the present invention can be used to form layers on other objects. Thus the present invention should not be limited by the above-described exemplary embodiments, but should be defined only in accordance with the following claims and their equivalents.

What is claimed is:

1. A method of forming a golf ball by compression molding an inner or cover layer around a golf ball core within a mold, the method comprising:
placing preformed hemispherical inner layer shells, one in each of an opposing upper and a lower mold cavity;
placing the golf ball core in the lower mold cavity;
holding the opposing mold portions together in a closed position by a first tonnage;
compressing the mold portions toward each other to the closed position, and applying heat and pressure therein;
activating a knockout retainer plate wherein knockout pins engage the golf ball to biasly eject it form the mold cavities; and
blowing high pressure air into the mold cavity to aid in releasing the ball from the mold cavity,
wherein the golf ball is removed from the mold cavities and the need of a release agent to coat the cavities is eliminated.

2. The method of claim 1, wherein the activating of the knockout pins is limited to a stroke of about 0.005 to 0.040 inch.

3. The method of claim 1, wherein the placing of the layers comprises a plurality of inner or cover layers into a plurality of mold cavities.

4. The method of claim 1, wherein the layer has a spherical lattice network comprising octahedron, cubactahedron, icosahedron, or icosadodecadron.

5. The method of claim 1, wherein the layer is a discontinuous layer comprising a plurality of discrete circular, triangular, or hexagonal elements.

6. The method of claim 1, wherein the inner and cover layers are comprised of a thermoplastic material.

7. The method of claim 1, wherein the inner and cover layers are comprised of a thermoset material.

8. A compression mold for molding a layer on a golf ball core, comprising:
mating lower and upper mold frames;
each frame having a channel for the admittance of a gas supply for creating a vacuum;
each frame having a knockout assembly comprising a retainer plate, a stationary wedge, and a moving wedge;
each retainer plate has a cavity defined therein which when make form a spherical recess the approximate size of a golf ball;
each frame having a vacuum bushing assembly comprising of retractable knockout pins for releasing the ball and matrix from within the cavity formed by the mold frames, O-ring seals around each knockout pin for preventing matter from entering or exiting the mold, and a vacuum bushing cap plate for retaining the O-ring seals; and
a high pressure air blow system for ejecting the layered golf ball from the cavity,
wherein each retainer plate by means of a controlled ejection stroke activate the knockout pins resulting in an ejection of the layered golf ball core without the use of a mold release agent.

9. The mold of claim 8, wherein the high pressure air blow system is a pressurized gas system and includes a pressurizer for creating a counter pressure within said holes around said pins.

10. The mold of claim 8, wherein each cavity includes an inverted dimple pattern for forming dimples on an outer surface of the layer.

11. The mold of claim 8, wherein the system is selected to withstand a material pressure of approximately 25,000 psi.
